(19) United States
(12) Patent Application Publication
(10) Pub. No.: US 2013/0219258 A1
(43) Pub. Date: Aug. 22, 2013

(54) METHOD AND DEVICE FOR POPULATING A CONTACT ENTRY WITH CONTEXTUAL INFORMATION

(71) Applicant: Prateek Bhatnagar, Waterloo (CA)

(72) Inventor: Prateek Bhatnagar, Waterloo (CA)

(73) Assignee: RESEARCH IN MOTION LIMITED, Waterloo, ON (CA)

(21) Appl. No.: 13/583,265

(22) PCT Filed: Jul. 7, 2011
(86) PCT No.: PCT/CA11/50416

§ 371 Date: Sep. 7, 2012

(51) Int. Cl. G06F 17/24

(52) U.S. Cl. CPC G06F 17/243
USPC 715/226

(57) ABSTRACT

Methods and devices for populating a portion of a contact entry are described. In one aspect, a method comprises: receiving a contact entry, the contact entry having a contact identifier; identifying, in a data store, a record which is associated with the contact identifier and which has a time identifier identifying a time that was prior to the time when the contact entry was received; and populating a portion of the contact entry with data from the identified record.

### TECHNICAL FIELD

The present disclosure relates to systems for managing contact information, and more particularly to methods and electronic devices for populating a portion of a contact entry.

### BACKGROUND

Electronic and software-based systems for managing contact information generally require a user to manually enter contact details for a contact entry. Such information may include, for example, a first and last name associated with the contact, an address associated with the contact, one or more telephone numbers associated with the contact, and one or more email address associated with the contact.

The process of manually inputting data for a contact entry may be time consuming for a user. Furthermore, such manual input may consume system resources, such as battery resources and display resources. Furthermore, most contact managers only permit traditional contact information, such as address information and the like, to be added to a contact entry.

### BRIEF DESCRIPTION OF THE DRAWINGS

FIG. 1 is a block diagram illustrating an electronic device in accordance with example embodiments of the present disclosure;

FIG. 2 is a block diagram illustrating various data stores of an electronic device in accordance with example embodiments of the present disclosure;

FIG. 3 is a block diagram illustrating a message record in accordance with example embodiments of the present disclosure;

FIG. 4 is a block diagram illustrating a calendar event record in accordance with example embodiments of the present disclosure;

FIG. 5 is a block diagram illustrating a location record in accordance with example embodiments of the present disclosure;

FIG. 6 is a block diagram illustrating a contact entry in accordance with example embodiments of the present disclosure;

FIG. 7 is a flowchart illustrating an example method of populating a contact entry with contextual information in accordance with example embodiments of the present disclosure;

FIG. 8 is a flowchart illustrating an example method of populating a contact entry with contextual information in accordance with example embodiments of the present disclosure;

FIG. 9 is a block diagram illustrating an organisation chart record in accordance with example embodiments of the present disclosure; and

FIG. 10 is a flowchart of a method of populating a contact entry with data from an organisation chart in accordance with example embodiments of the present disclosure.

Like reference numerals are used in the drawings to denote like elements and features.

### DETAILED DESCRIPTION OF EXAMPLE EMBODIMENTS

In one aspect, the present disclosure describes a method performed by an electronic device having a memory and a processor coupled with the memory. The method includes: receiving a contact entry, the contact entry having a contact identifier; identifying, in a data store, a record which is associated with the contact identifier and which has a time identifier identifying a time that was prior to the time when the contact entry was received; and populating a portion of the contact entry with data from the identified record.

In another aspect, the present disclosure describes an electronic device including a memory and a processor coupled to the memory. The processor is configured to: receive a contact entry, the contact entry having a contact identifier; identify, in a data store, a record which is associated with the contact identifier and which has a time identifier identifying a time that was prior to the time when the contact entry was received; and populate a portion of the contact entry with data from the identified record.

In yet another aspect, the present disclosure describes a computer-readable medium having computer-executable instructions for causing an electronic device having a memory and a processor coupled therewith to: receive a contact entry, the contact entry having a contact identifier; identify, in a data store, a record which is associated with the contact identifier and which has a time identifier identifying a time that was prior to the time when the contact entry was received; and populate a portion of the contact entry with data from the identified record.

In yet a further aspect, the present disclosure describes a method for populating a portion of a contact entry. The contact entry has a contact identifier. The method includes: identifying, in a data store, an earliest record which is associated with the contact identifier; and populating at least a portion of the contact entry based on information contained in the identified record.

Other example embodiments of the present disclosure will be apparent to those of ordinary skill in the art from a review of the following detailed description in conjunction with the drawings.

As will be described in greater detail below, at least some example embodiments of the present disclosure describe electronic devices (such as a mobile communication device), methods, communication systems, and computer-readable mediums for populating a contact entry with contextual information. in an example embodiment, the contextual information includes information which describes the relationship between the user of the device and the contact.

The contextual information may, for example, contain information regarding the first interaction between the user and the contact. In other example embodiments, the contextual information may contain information regarding the most recent interaction between the user and the contact.

Tracking such contextual information may aid the user in remembering the nature of the user's relationship with the contact. Furthermore, by including contextual information in a contact entry, a user may use the contextual information as a search term when looking for a contact. For example, a user may recall that they first met a specific person at a trade show but may not recall the name of that person. In such cases, they may search for the contact using the name of the trade show where they met.

### Example Electronic Device

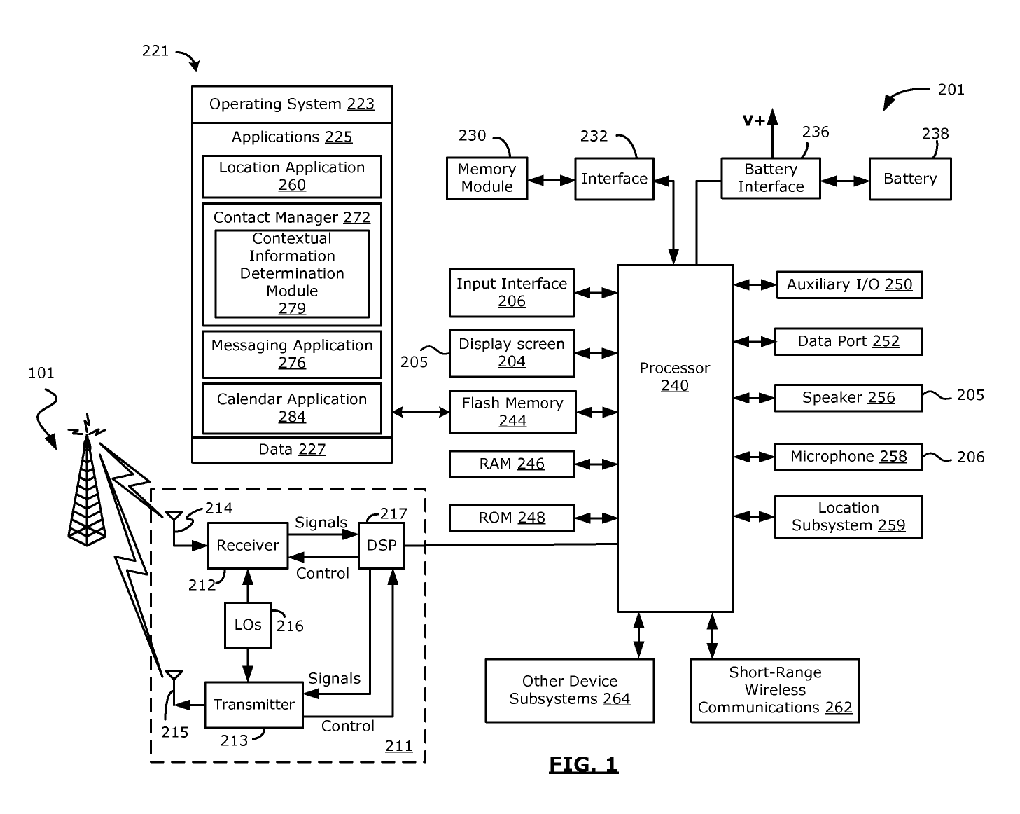

An overview having been provided, reference will now be made to FIG. 1 which illustrates an example device 201 in which example embodiments described in the present disclosure can be applied. In the illustrated example embodiment, the device 201 is an electronic device 201 and, more particularly, is a mobile communication device 201 having data and voice communication capabilities, and the capability to communicate with other computer systems; for example, via the Internet. Depending on the functionality provided by the electronic device 201, in various example embodiments the electronic device 201 may be a multiple-mode communication device configured for both data and voice communication, a smartphone, a tablet computer, a mobile telephone or a PDA (personal digital assistant) enabled for wireless communication, or a computer system. The electronic device 201 may also be referred to as a mobile communications device 201, a communication device 201, an electronic device 201, a mobile device 201 and, in some cases, as a device 201.

The device 201 includes a controller including at least one processor 240 (such as a microprocessor) which controls the overall operation of the device 201. The processor 240 interacts with device subsystems such as a wireless communication subsystem 211 for exchanging radio frequency signals with a wireless network 101 to perform communication functions. The processor 240 is communicably coupled with additional device subsystems including one or more output interfaces 205 (such as a display screen 204 and/or a speaker 256), one or more input interfaces 206 (such as a microphone 258, keyboard (not shown), control buttons (not shown), a navigational input device (not shown), and/or a touch-sensitive overlay (not shown)), memory (such as flash memory 244, random access memory (RAM) 246, read only memory (ROM) 248, etc.), auxiliary input/output (I/O) subsystems 250, data port 252 such as serial data port, such as a Universal Serial Bus (USB) data port, short-range communication subsystem 262, a location subsystem 259 (such as a global positioning system (GPS) for communicating with a GPS satellite network (not shown)) and other device subsystems generally designated as 264. Some of the subsystems shown in FIG. 1 perform communication-related functions, whereas other subsystems may provide “resident” or on-device functions.

In at least some example embodiments, the device 201 may include a touchscreen display which acts as both an input interface 206 (i.e. touch-sensitive overlay) and an output interface 205 (i.e. display). The touchscreen display may be constructed using a touch-sensitive input surface connected to an electronic controller and which overlays the display screen 204. The touch-sensitive overlay and the electronic controller provide a touch-sensitive input device and the processor 240 interacts with the touch-sensitive overlay via the electronic controller.

The communication subsystem 211 includes a receiver 212, a transmitter 213, and associated components, such as one or more antenna elements 214 and 215, local oscillators (LOs) 216, and a processing module such as a digital signal processor (DSP) 217. The antenna elements 214 and 215 may be embedded or internal to the mobile device 201 and a single antenna may be shared by both receiver and transmitter, as is known in the art. As will be apparent to those skilled in the field of communication, the particular design of the wireless communication subsystem 211 depends on the wireless network 101 in which mobile device 201 is intended to operate.

The mobile communication device 201 may communicate with any one of a plurality of fixed transceiver base stations of the wireless network 101 within its geographic coverage area. The mobile communication device 201 may send and receive communication signals over the wireless network 101 after the required network registration or activation procedures have been completed. Signals received by the antenna 214 through the wireless network 101 are input to the receiver 212, which may perform such common receiver functions as signal amplification, frequency down conversion, filtering, channel selection, etc., as well as analog-to-digital (A/D) conversion. A/D conversion of a received signal allows more complex communication functions such as demodulation and decoding to be performed in the DSP 217. In a similar manner, signals to be transmitted are processed, including modulation and encoding, for example, by the DSP 217. These DSP-processed signals are input to the transmitter 213 for digital-to-analog (D/A) conversion, frequency up conversion, filtering, amplification, and transmission to the wireless network 101 via the antenna 215. The DSP 217 not only processes communication signals, but may also provide for receiver and transmitter control. For example, the gains applied to communication signals in the receiver 212 and the transmitter 213 may be adaptively controlled through automatic gain control algorithms implemented in the DSP 217.

In some example embodiments, the auxiliary input/output (I/O) subsystems 250 may include an external communication link or interface, for example, an Ethernet connection. The mobile communication device 201 may include other wireless communication interfaces for communicating with other types of wireless networks; for example, a wireless network such as an orthogonal frequency division multiplexed (OFDM) network. The auxiliary I/O subsystems 250 may include a vibrator for providing vibratory notifications in response to various events on the mobile communication device 201 such as receipt of an electronic communication or incoming phone call, or for other purposes such as haptic feedback (touch feedback).

In some example embodiments, the mobile communication device 201 also includes a removable memory module 230 (typically including flash memory, such as a removable memory card) and a memory interface 232. Network access may be associated with a subscriber or user of the mobile communication device 201 via the memory module 230, which may be a Subscriber Identity Module (SIM) card for use in a GSM network or other type of memory card for use in the relevant wireless network type. The memory module 230 is inserted in or connected to the memory card interface 232 of the mobile communication device 201 in order to operate in conjunction with the wireless network 101.

The data port 252 may be used for synchronization with a user's host computer system (not shown). The data port 252 enables a user to set preferences through an external device or software application and extends the capabilities of the mobile communication device 201 by providing for information or software downloads to the mobile communication device 201 other than through the wireless network 101. The alternate download path may, for example, be used to load an encryption key onto the mobile communication device 201 through a direct, reliable and trusted connection to thereby provide secure device communication.

In some example embodiments, the mobile communication device 201 is provided with a service routing application programming interface (API) which provides an application with the ability to route traffic through a serial data (i.e., USB) or Bluetooth® (Bluetooth® is a registered trademark of Bluetooth SIG, Inc.) connection to a host computer system using standard connectivity protocols. When a user connects their mobile device 201 to the host computer system via a USB cable or Bluetooth® connection, traffic that was destined for the wireless network 101 is automatically routed to the mobile device 201 using the USB cable or Bluetooth® connection. Similarly, any traffic destined for the wireless network 101 is automatically sent over the USB cable Bluetooth® connection to the host computer system for processing.

The mobile communication device 201 also includes a battery 238 as a power source, which is typically one or more rechargeable batteries that may be charged, for example, through charging circuitry coupled to a battery interface 236 such as the data port 252. The battery 238 provides electrical power to at least some of the electrical circuitry in the mobile communication device 201, and the battery interface 236 provides a mechanical and electrical connection for the battery 238. The battery interface 236 is coupled to a regulator (not shown) which provides power V+ to the circuitry of the mobile communication device 201.

The short-range communication subsystem 262 is an additional optional component which provides for communication between the mobile device 201 and different systems or devices, which need not necessarily be similar devices. For example, the subsystem 262 may include an infrared device and associated circuits and components, or a wireless bus protocol compliant communication mechanism such as a Bluetooth® communication module to provide for communication with similarly-enabled systems and devices.

The mobile device 201 stores data 227 in an erasable persistent memory, which in one example embodiment is the flash memory 244. In various example embodiments, the data 227 includes service data including information required by the mobile device 201 to establish and maintain communication with the wireless network 101. The data 227 may also include user application data such as email messages, address book and contact information, calendar and schedule information, notepad documents, image files, and other commonly stored user information stored on the mobile device 201 by its user, and other data. The data 227 stored in the persistent memory (e.g. flash memory 244) of the mobile device 201 may be organized, at least partially, into a number of databases or data stores each containing data items of the same data type or associated with the same application. For example, email messages, contact records, and task items may be stored in individual databases within the device memory.

The mobile communication device 201 may, in some example embodiments, provide two principal modes of communication: a data communication mode and a voice communication mode. In the data communication mode, a received data signal such as a text message, an email message, or Web page download will be processed by the communication subsystem 211 and input to the processor 240 for further processing. For example, a downloaded Web page may be further processed by a browser application or an email message may be processed by an email messaging application and output to the display 204. A user of the mobile communication device 201 may also compose data items, such as email messages, for example, using the input devices in conjunction with the display screen 204. These composed items may be transmitted through the communication subsystem 211 over the wireless network 101.

In the voice communication mode, the mobile communication device 201 provides telephony functions and operates as a typical cellular phone. The overall operation is similar, except that the received signals would be output to the speaker 256 and signals for transmission would be generated by a transducer such as the microphone 258. The telephony functions are provided by a combination of software/firmware (i.e., the voice communication module) and hardware (i.e., the microphone 258, the speaker 256 and input interfaces 206). Alternative voice or audio I/O subsystems, such as a voice message recording subsystem, may also be implemented on the mobile communication device 201. Although voice or audio signal output is typically accomplished primarily through the speaker 256, the display screen 204 may also be used to provide an indication of the identity of a calling party, duration of a voice call, or other voice call related information.

The processor 240 operates under stored program control and executes software modules 221 stored in memory such as persistent memory; for example, in the flash memory 244. As illustrated in FIG. 1, the software modules 221 include operating system software 223 and other software applications 225 such as a location application 260 (which may be a GPS application), a contact manager 272, a messaging application 276 and a calendar application 284. In the example embodiment of FIG. 1, the location application 260, contact manager 272, messaging application 276 and calendar application 284 are implemented as separate stand-alone applications 225. However, in other example embodiments, one or more of these applications (i.e. the location application 260, the contact manager 272, the messaging application 276, and/or the calendar application 284) could be implemented as part of the operating system 223 or another application 225. In some example embodiments, the function performed by any combination of the location application 260, the contact manager 272, the messaging application 276, and/or the calendar application 284 may be realized in a common application. For example, the contact manager 272, the messaging application 276 and/or the calendar application 284 may be implemented as a single application which provides for all of the functions of the contact manager 272, messaging application 276, and/or contact manager 272.

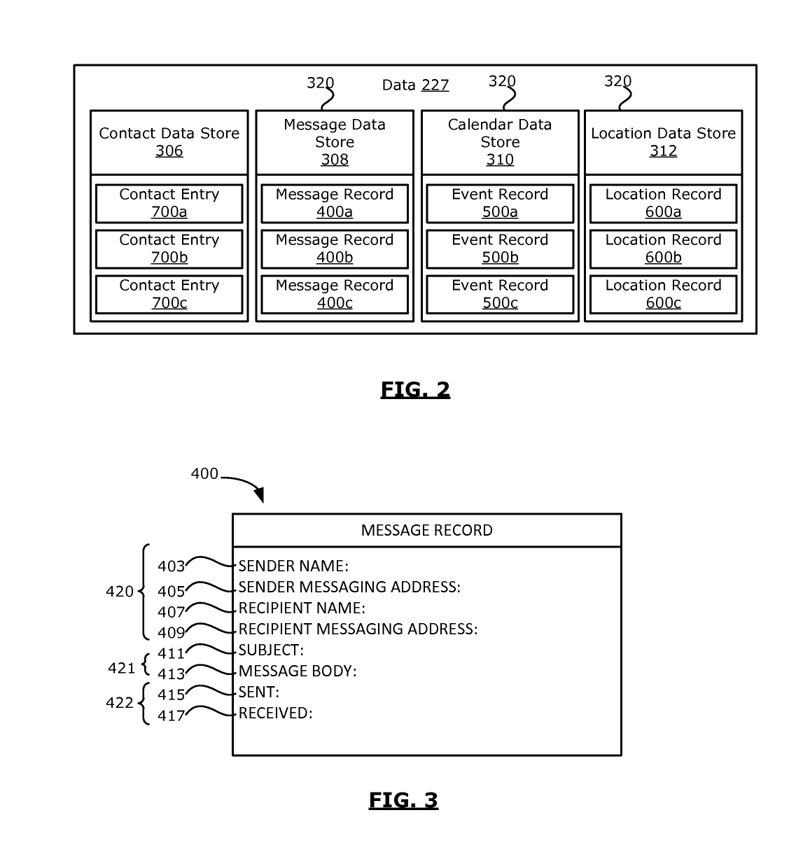

The location application 260 uses the location subsystem 259 (such as a GPS transceiver) to collect information about the device's present location and, in some example embodiments, stores this information in a location data store 312 (FIG. 2) (which may be a GPS data store). In some example embodiments, the location application 260 may perform additional functions, possibly in conjunction with an integrated or separate mapping application, including displaying present or past location of the device 201 on a map, providing one or more notifications of nearby landmarks through one of the output interfaces 205 (such as the display screen 204), and providing driving directions through one of the output interfaces 205 (such as the display screen 204 and/or the speaker 256) based on a current location of the device 201 and a planned destination. The location application 260 may provide for other functionality instead of or in addition to the functionality described above.

The calendar application 284 may be configured to facilitate the scheduling of calendar events. The calendar application 284 may also be configured to output reminders to one of the output interfaces 205 regarding upcoming calendar events (such reminders may be referred to as appointment or meeting reminders). In at least some example embodiments, the calendar application 284 handles meeting invitations (which may also be referred to as appointments) which are sent and received over the network 124 (FIG. 1) via the messaging application 276. In at least some example embodiments, the calendar application 284 is configured to store calendar event records 500a, 500b, 500c (FIG. 2) in a calendar data store 310 (FIG. 2).

The messaging application 276 enables the composition of data items, such as electronic messages. Such composed items may then be transmitted over a communication network through the wireless communication subsystem 211. Messages can also be received through the wireless communication subsystem 211 for processing by the messaging application 276. In at least some example embodiments, the messaging application 276 is an email messaging application for composing, receiving and/or sending email messages. However, other types of messaging applications 276 are also possible. For example, in at least some example embodiments, the messaging application 276 may provide for composing, sending and/or receiving messages of any one or more of the following messaging types: email messages, text messages, Short Message Service (SMS) messages, Multimedia Messaging Service (MMS) messages, device-to-device messages (which may rely on the use of a personal identification number (PIN) which is programmed into a memory of devices at the time of manufacture), and/or instant messages. Other types of messages are also possible.

The messaging application 276 may store messages (such as email messages) as message records 400a, 400b, 400c (FIG. 2) in a message data store 308 (FIG. 2) which stores a plurality of message records 400a, 400b, 400c.

The contact manager 272 performs the functions of an address book and allows contact entries 700a, 700b, 700c (FIG. 2) to be created and stored in a contact data store 306 (FIG. 2) of the memory. The contact manager 272 is configured to receive new contact entries from one or more input interface 206 associated with the device 201. For example, a user of the device 201 may interact with an input interface 206 such as a navigational input device in order to input an instruction to the contact manager 272 to create a new contact entry 700a, 700b, 700c (FIG. 2). The new contact entry may include a contact identifier which identifies a contact associated with the contact identifier. The contact identifier may be received from one or more input interface 206 associated with the device 201. For example, a user of the device 201 may interact with the input interface 206 to input one or more contact identifiers associated with the contact entry. The contact identifier may, for example, be a name associated with the contact entry. In other example embodiments, the contact identifier may be a messaging address (such as an email message) associated with the contact entry.

In at least some example embodiments, a contact entry may be received at the contact manager 272 over a network from another device or system. For example, the contact entry may be received via the communication subsystem 211. The contact entry may be received in vCard format or in another format which describes contact information.

In at least some example embodiments, the contact manager 272 may include a contextual information determination module 279. As will be explained in greater detail below, the contextual information determination module 279 is configured to populate at least a portion of a contact entry with contextual information for a contact. Such contextual information may be determined by scanning one or more of the data stores 308, 310, 312 (FIG. 2) to identifying a record in the data store which is associated with the same contact identifier and which has a time identifier that identifies a time that was prior to the time when the contact entry was received. That is, the contact information determination module 279 may be configured to attempt to locate one or more records in a message data store 308, a calendar data store 310, and/or a location data store 312 which are associated with the same contact identifier as the new contact entry and which predated the new contact entry. The contact entry may then be populated with information from the identified record.

The software applications 225 may include a range of additional applications, including, for example, a notepad application, Internet browser application, voice communication (i.e. telephony) application, mapping application, or a media player application, or any combination thereof. Each of the software applications 225 may include layout information defining the placement of particular fields and graphic elements (e.g. text fields, input fields, icons, etc.) in the user interface (i.e. the display screen 204) according to the application.

Those skilled in the art will appreciate that the software modules 221 or parts thereof may be temporarily loaded into volatile memory such as the RAM 246. The RAM 246 is used for storing runtime data variables and other types of data or information, as will be apparent to those skilled in the art. Although specific functions are described for various types of memory, this is merely one example, and those skilled in the art will appreciate that a different assignment of functions to types of memory could also be used.

A predetermined set of applications that control basic device operations, including data and possibly voice communication applications will normally be installed on the mobile communication device 201 during or after manufacture. Additional applications and/or upgrades to the operating system 223 or software applications 225 may also be loaded onto the mobile communication device 201 through the wireless network 101, the auxiliary I/O subsystem 250, the data port 252, the short-range communication subsystem 262, or other suitable subsystem 264. The downloaded programs or code modules may be permanently installed, for example, written into the program memory (i.e. the flash memory 244), or written into and executed from the RAM 246 for execution by the processor 240 at runtime.

### Data Stores

The location application 260 (which may be a GPS application), contact manager 272, messaging application 276 and calendar application 284 may store data in respective data stores in the data 227 area of memory (such as flash memory 244). For example, referring now to FIG. 2, an example of data 227 in a memory is illustrated. The data 227 includes a plurality of data stores, including a contact data store 306 (which includes contact entries 700a, 700b, 700c), a message data store 308 (which includes message records 400a, 400b, 400c), a calendar data store 310 (which includes event records 500a, 500b, 500c) and a location data store 312 (which includes location records 600a, 600b, 600c). The applications 225 (FIG. 1) on the device 201 (FIG. 1) may access the contact data store 306, the message data store 308, the calendar data store 310 and/or the location data store 312.

In at least some example embodiments, the data stores 306, 308, 310 and 312 may have one or more applications 225 (FIG. 1) associated therewith for accessing and/or generating data for that data store 306, 308, 310, 312. For example, in at least some example embodiments, the location application 260 (FIG. 1) (which may be a GPS application) may generate data for and/or access data from the location data store 312. Similarly, in at least some example embodiments, the contact manager 272 (FIG. 1) may generate data for and/or access data from the contact data store 306. Similarly, in at least some example embodiments, the calendar application 284 (FIG. 1) may generate data for and/or access data from the calendar data store 310. In at least some example embodiments, the messaging application 276 (FIG. 1) may generate data for and/or access data from the message data store 308.

It will be appreciated that, in some example embodiments, any one or more of the data stores 306, 308, 310, 312 may be accessed by a plurality of applications. For example, in at least some example embodiments, the contact data store 306 may be accessed by the contact manager 272 which operates to manage the data in the contact data store 306 and by the messaging application 276 which may use data in contact entries in the contact data store 306 for populating at least some fields of an electronic message (such as a “To” field).

In some example embodiments, any one or more of the data stores 306, 308, 310, 312 may be accessed by the contact manager 272 (FIG. 1). More particularly, in at least some example embodiments, the contact manager 272 (FIG. 1) may be configured to create contact entries 700a, 700b, 700c for contacts associated with a user or account associated with the device 201 (FIG. 1).

At least some of the data stores may be contextual information data stores 320 which may store information that may be used to determine contextual information for a contact. In an example embodiment, contextual information includes information about a user's relationship with the contact. In various example embodiments, the message data store 308, the calendar data store 310 and the location data store 312 may each be used to determine contextual information for a contact entry 700a, 700b, 700c. That is, the contextual information data stores 320 may be used to determine contextual information which describes the nature of the relationship between the contact and the user of the device 201 (FIG. 1).

For example, in various example embodiments, the contextual information determination module 279 (FIG. 1) may use the contextual information data stores 320 to determine contextual information for a contact. As will be described in greater detail below, such contextual information may, in some example embodiments, describe the earliest interaction between the user of the device 201 (FIG. 1) and the contact described by a contact entry. For example, the contextual information may describe the party who introduced the user of the device 201 (FIG. 1) to the contact described by the contact entry, the subject of the first meeting between the user of the device 201 (FIG. 1) and the contact, the time (including the time of day and the date) of the first meeting between the user of the device 201 (FIG. 1) and the contact, the location of the first meeting between the user of the device 201 (FIG. 1) and the contact, the reason for the first meeting between the user of the device 201 (FIG. 1) and the contact, the nature of the first meeting between the user of the device 201 (FIG. 1) and the contact (i.e. whether the meeting was an in-person meeting, telephone meeting, videoconference meeting, etc).

Such contextual information may also, in at least some example embodiments, describe the most recent interaction between the user of the device 201 (FIG. 1) and the contact described by the contact entry. For example, the contextual information may identify the time (including the time of day and the date) of the most recent meeting between the user of the device 201 (FIG. 1) and the contact associated with the contact entry. The contextual information may, in at least some example embodiments, describe the subject of the last meeting between the user of the device 201 (FIG. 1) and the contact associated with the contact entry. The contextual information may, in at least some example embodiments, describe the location of the last meeting between the user of the device 201 (FIG. 1) and the contact associated with the contact entry. The contextual information may, in at least some example embodiments, specify whether the user of the device 201 (FIG. 1) and the contact have met recently (i.e. whether the elapsed time since the last meeting exceeds a predetermined threshold.

As will be described in greater detail below, when the contextual information determination module 279 (FIG. 1) identifies contextual information, the contextual information determination module 279 (FIG. 1) may populate a portion of a contact entry with the contextual information.

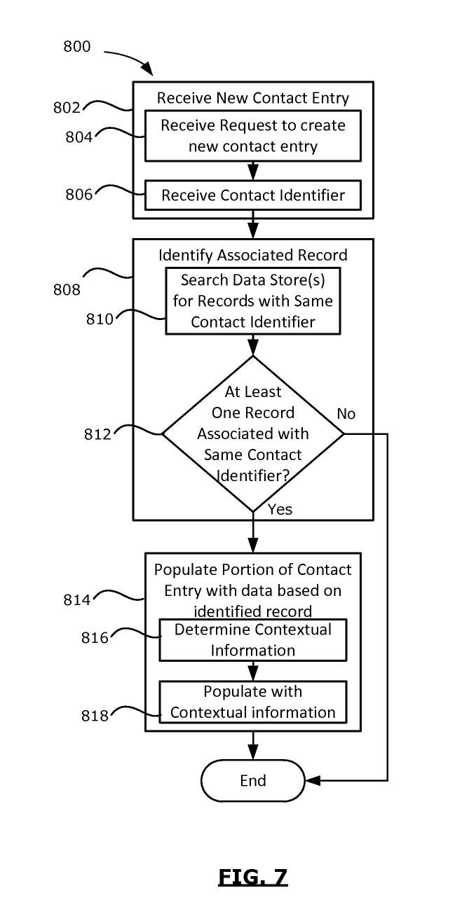

The records 400, 500, 700 associated with each type of the contextual data stores 320 will now be discussed in greater detail. These records include message records 400 (an example of which is shown in FIG. 3) which may be stored in the message data store 308, calendar event records 700 (an example of which is shown in FIG. 6) which may be stored in the calendar data store 310 and location records 600 (an example of which is shown in FIG. 5) which may be stored in the location data store 312.

### Message Records

Referring now to FIG. 3, a message record 400 is illustrated in accordance with an example embodiment of the present disclosure. The message record 400 is associated with an electronic message. The electronic message may be a received message (i.e. a message sent by another and received at the device 201 (FIG. 1)) or, in at least some example embodiments, a sent message (i.e. a message sent from the device 201 (FIG. 1) to another).

The message record 400 contains message data which may be stored in one or more data fields. The message record may include one or more contact identifiers 420. The contact identifiers 420 identify a contact. The contact identifiers 420 may, in at least some example embodiments, be unique or near-unique identifiers. In at least some example embodiments, the contact identifiers 420 may include a sender name 403, a sender messaging address 405 (such as a sender email address), a recipient name 407, and/or a recipient messaging address 409 (such as a recipient email address). In some example embodiments, the message record 400 may include multiple recipient fields 407, 409 indicating more than one recipient, and may include recipients of different types (such as “To”, “CC”, and “BCC” recipient for email messages).

The message record 400 may also include at least some message content 421. In the example illustrated, the message content 421 includes a subject 411 of the message and a message body 413 of the message. The subject 411 includes a brief description of the content of the message record 400. The message body 413 includes at least some of the content of the message.

The message record 400 also includes one or more time identifiers 422. A time identifier 422 identifies a time which is associated with the message. In the example illustrated, the time identifiers 422 include a sent time identifier 415 and a received time identifier 417. The sent time identifier 415 identifies a time (in terms of a time of day and date) when the message was originally sent by the sender. The received time identifier 417 identifies a time (in terms of a time of day and a date) when the message was originally received by a recipient. It will be appreciated that, due to transmission delays, the sent time identifier 415 may have a different time associated therewith than the received time identifier 417.

### Calendar Event Records

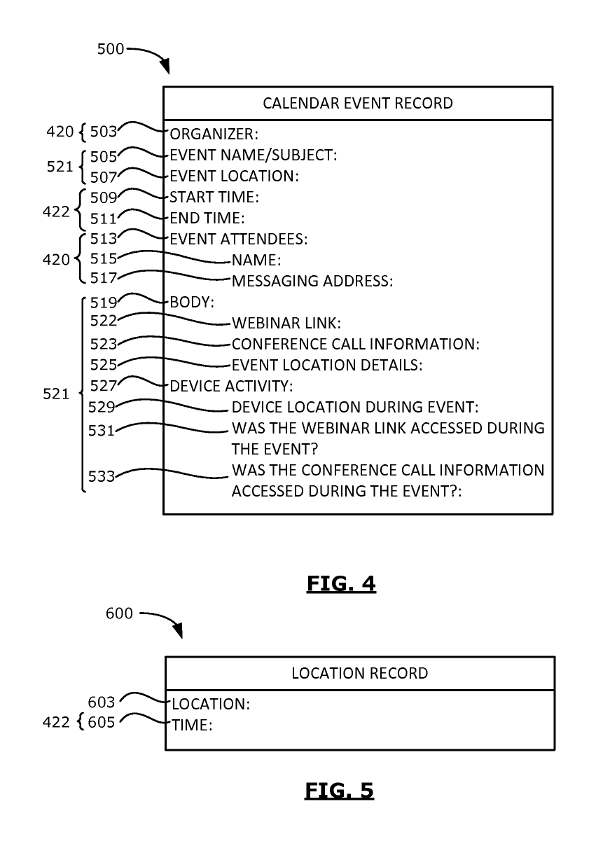

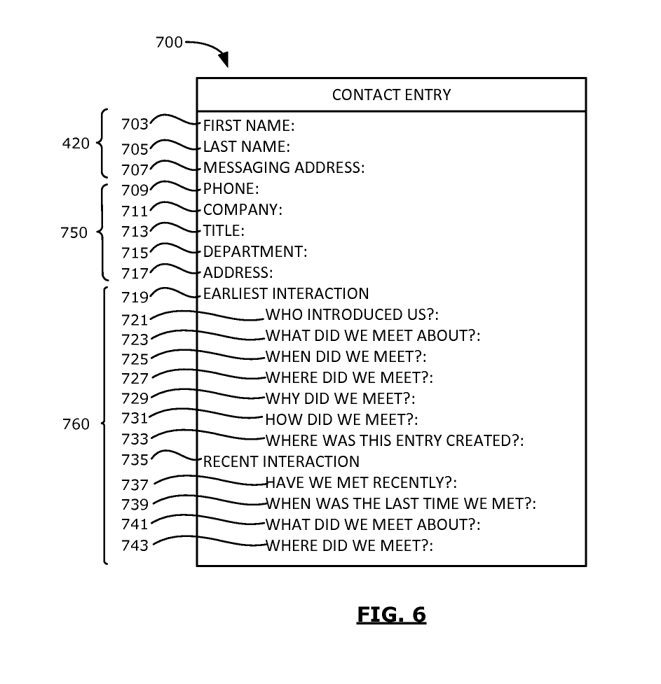

Referring now to FIG. 4, a calendar event record 500 according to an example embodiment of the present disclosure is illustrated. The calendar event record 500 relates to a single entry in the calendar and contains several data fields which store data for a calendar event. The calendar event record includes at least one contact identifier 420. The contact identifier 420 for the calendar event record 500 may identify one or more event attendees 513 who attended the event defined by the calendar event record 500. The event attendees 513 may be identified by name 515. The name 515 may be a text field containing the attendee's first name and last name. The event attendees 513 may, in at least some example embodiments, be identified by messaging address 517. The messaging address 517 may, in at least some example embodiments, be an email address.

The contact identifiers 420 for the event record 500 may, in at least some example embodiments, identify an organizer for the event. The organizer for the event may be identified, for example, by a name and/or messaging address associated with the organizer 503.

In at least some example embodiments, at least some of the contact identifier 420 information may be stored in a separate data store or record, apart from the calendar data store 310 (FIG. 2). For example, in some example embodiments, an event record may link or point to records which are external to the calendar data store 310 (FIG. 2) or which are sub-records (i.e. records within records) within the calendar data store 310 (FIG. 2).

The calendar event record 500 may also include at least some event content 521. The event content 521 contains additional information about the event. In the illustrated example embodiment, the event content 521 includes an event name 505 field (which may also be referred to as a subject field). The event name field includes a short descriptor which may be used to identify the event. The event content 521 may also include an event location 507 which contains information which identifies the location of the event.

The event content 521 may also include a body 519 which may contain miscellaneous information about the event such as instructions for attendance. In at least some example embodiments, the event content 521 may specify a webinar link 522. The webinar link 522 may, for example, be included in the body 519. The webinar link may be a uniform resource locator or other pointer which points to an online communication resource used for the event. The event content 521 may also include conference call information 523. The conference call information 523 may be included in the body 519. The conference call information 523 may specify information which is used to connect to a conference call. The conference call information may include a telephone number and, in at least some example embodiments, an authentication code which must be input in order to join the conference call.

The event content 521 may also include event location details 525. The event location details 525 may, for example, be included in the body 519. The event location details may be related to the event location 507. However, in at least some example embodiments, the event location details 525 may provide additional information regarding the event location which are not provided in the event location 507 field. For example, the event location details 525 may specify directions for travelling to the event.

In at least some example embodiments, the event content 521 may also include device activity information 527. The device activity information may specify information regarding the activity of the device 201 (FIG. 1) during the event. Such information may specify, for example, whether the device 201 (FIG. 1) was in use during the event, whether any applications 225 (FIG. 2) on the device were in use during the event and, if so, the name or other identifier of any such applications 225. The device activity information 527 may also specify the location of the device 201 (FIG. 1) during the event. The location of the device may be determined using the location subsystem 259 (FIG. 1). The device activity information 527 may also specify whether the device 201 (FIG. 1) was engaged in a telephone call during the event and, if so, the telephone number associated with the telephone call.

By way of example, in the example embodiment of FIG. 4, the device activity information 527 includes a device location during the event field 529 which specifies the location of the device 201 during the event. The device location during the event field 529 may link to or contain a location record, such as the location record 600 described below with reference to FIG. 5.

The example embodiment illustrated in FIG. 4 also includes a field 531 which specifies whether a webinar link was accessed on the device 201 during the event. The example embodiment also includes a field 533 which specifies whether conference call information was accessed during the event.

The device activity fields 527, 529, 531, 533 may be automatically populated in the calendar event record by the device 201 (FIG. 1) in response to activity on the device 201 (FIG. 1) during the event.

It will be appreciated that the event record 500 may specify other event content 521 instead of or in addition to any of the event content 521 discussed above.

The event record 500 also includes one or more time identifiers 422. The time identifiers 422 identify a time which is associated with the event. In the example illustrated, the time identifiers 422 include an event start time identifier 509 and an event end time identifier 511. The event start time identifier 509 identifies a time (in terms of a time of day and date) when the event was scheduled to begin. The end time identifier 511 identifies a time (in terms of a time of day and a date) when the event was scheduled to end. It will be appreciated that other time identifiers 422 may be used instead of or in addition to the time identifiers discussed above. For example, in at least some example embodiments, the event record 500 may include an event duration (not shown) which specifies a predicted or actual time duration of the event.

It will be appreciated that, in at least some example embodiments, some of the information discussed above with reference to the event record 500 may not be included in the event record 500 itself but may, instead, be included in another record in another data store. In such example embodiments, the event record 500 may include a link, pointer, or other identifier which links to the other record or other data store. In some example embodiments, some of the information discussed above may be included within a sub-record of the calendar event record (i.e. a record within the calendar event record).

### Location Records

Referring now to FIG. 5, a location record 600 according to an example embodiment of the present disclosure is illustrated. The location record 600 may be included in a location data store 312 (FIG. 2).

The location record 600 relates a location 603 of the device 201 with a time identifier 422 which identifies a time 605 (in terms of a time of day and a date) when the device 201 was at the associated location 603.

The location 603 of the device 201 (FIG. 1) may be determined, for example, by a location application 260 (FIG. 1) which communicates with a location subsystem 259 (FIG. 1), such as a GPS subsystem.

The number of past locations 603 stored on a device 201, and the circumstances in which these past locations are updated, stored, or retired, varies across different example embodiments and may depend on user-configurable settings in the location application 260. Some example embodiments may store the location as a set of GPS or other spatial coordinates (such as spatial data derived from the location of communication base stations used by the device), while other example embodiments may store them as the name of an identifiable location or a pointer to a location record containing both coordinates and a name or description for the location.

Some example embodiments may also link the address fields in various record types with GPS or other location information, either by using a common format for both, by translating between the two using a mapping application, or by storing a list of addresses and their corresponding location information.

### Contact Record

According to some example embodiments of the present disclosure, a portion of a contact entry may be populated with contextual information which is determined using the message data store 308 (FIG. 2), the calendar data store 310 (FIG. 2) and/or the location data store 312 (FIG. 2). The identification of contextual information from the message data store 308 (FIG. 2) may be triggered in response to the receipt of a new contact entry which includes one or more contact identifiers 420.

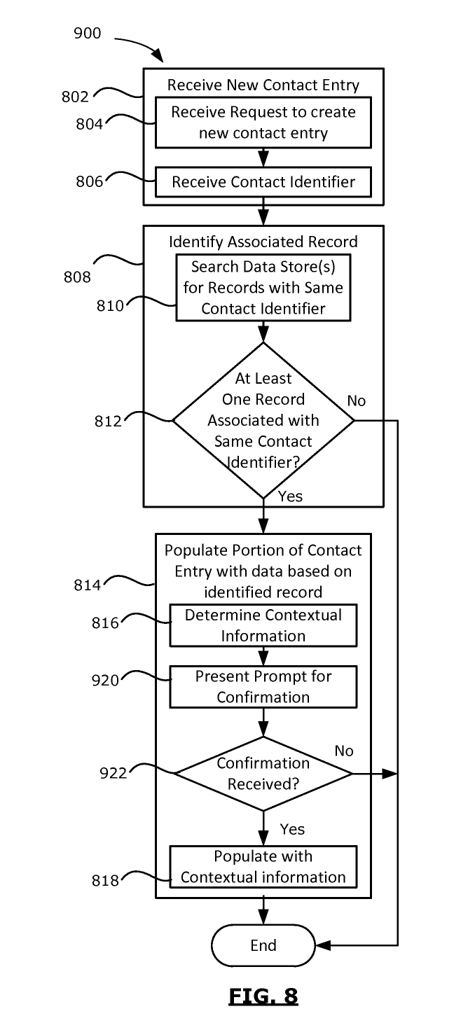

Such contact entries 700 will now be discussed with reference to FIG. 7. Referring now to FIG. 7, a contact entry 700 according to an example embodiment of the present disclosure is illustrated. The contact entry 700 may be included in a contact data store 306 (FIG. 2).

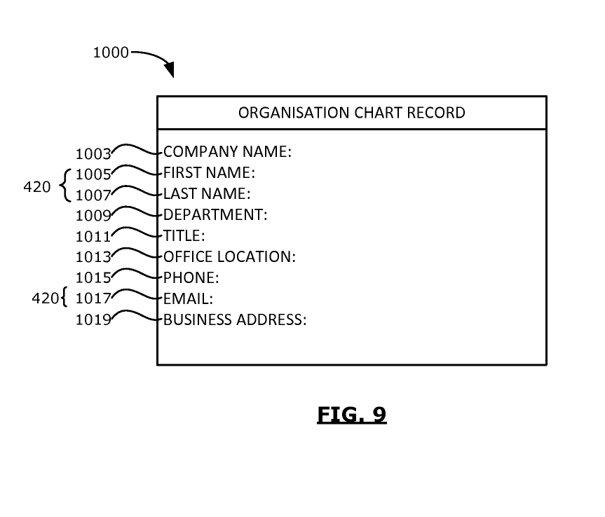

The contact entry 700 includes one or more contact identifiers 420. As will be explained in greater detail below with reference to FIG. 7, the contact identifiers 420 may be used to identify records in other data stores, such as the message data store 308, calendar data store 310 and location data store 312, which are associated with the same contact identifiers 420. As will be discussed in greater detail with reference to FIG. 8, contextual information may be extracted from such identified records and used to populate portions of the contact entry 700.

The contact identifiers 420 include one or more name which, in the example embodiment, includes a first name 703 and a last name 705. The contact identifiers 420 of the contact entry 700 also include a messaging address 707. The messaging address 707 is, in at least some example embodiments, an email address associated with the contact.

The contact entry 700 includes other biographical and contact information 750 for a contact, including, for example, a phone number 709, company name 711, job title 713, department 715, and/or a street or mailing address 717. Other contact or biographical information may also be included.

The contact entry 700 also includes contextual information 760 which provides information regarding the relationship between the user of the device 201 (FIG. 1) (i.e. the owner of the contact data store 306 (FIG. 2)) and the contact associated with the contact entry 700. The contextual information 760 may include data identifying the earliest interaction 719 between the user of the device 201 (i.e. the owner of the contact data store) and the contact associated with the contact entry 700. In at least some example embodiments, the contextual information 760 may include data identifying the most recent interaction 735 between the user of the device 201 (i.e. the owner of the contact data store) and the contact associated with the contact entry 700.

The contextual information 760 may, in various example embodiments, include any one or more of the following: a field and/or data 721 for specifying a person who introduced the user of the device 201 to the contact defined in the contact entry 700, a field and/or data 723 for specifying the subject of the first interaction between the user of the device 201 (FIG. 1) and the contact defined in the contact entry 700, a field and/or data 725 for specifying the time (i.e. in terms of the time of day and date) of the first interaction between the user of the device 201 (FIG. 1) and the contact defined in the contact entry 700, a field and/or data 727 for specifying the location of the first interaction between the user of the device 201 (FIG. 1) and the contact defined in the contact entry 700, a field and/or data 729 for specifying the reason for the first interaction between the user of the device 201 (FIG. 1) and the contact defined in the contact entry 700, a field and/or data 731 for specifying the method used to meet during the first interaction (i.e. videoconference, telephone, in-person), a field and/or data 733 for specifying a location information for the device 201 (FIG. 1) at the time a contact entry 700 for a new contact was created.

The contextual information 760 may also include a field and/or data 735 for specifying details regarding the most recent interaction between the user of the device 201 and the contact defined in the contact entry 700. Such information may include, for example, a field and/or data 737 for identifying whether the contact and the user have been joint attendees at a recent event, a field and/or data 739 for identifying a time (in terms of a time of day and a date) of the most recent interaction between the user and the contact, a field and/or data 741 for identifying information about the subject of the contact and user's last meeting or interaction, a field and/or data 743 for identifying the location of the most recent meeting between the user and the contact.

It will be appreciated that other contextual information 760 may be included in a contact entry 700 instead of or in addition to the contextual information 760 discussed above.

At least some of the information discussed above, such as the contextual information 760, may not be stored directly within the contact entry 700. In at least some example embodiments, at least some of this information may be stored in another record which may be located in another data store. In such example embodiments, the contact entry 700 may contain a pointer to the record which stores the additional information.

### Populating a Contact Entry

At least some of the contextual information 760 may be populated by the device 201 (FIG. 1) by pulling the contextual information 760 from other records associated with the same contact. That is, the device 201 (FIG. 1) may be equipped to populate the contact entry 700 with contextual information which is determined from other records.

Referring now to FIG. 7, a flowchart of a method 800 for populating a contact entry 700 (FIG. 6) is illustrated. The device 201 (FIG. 1) may be configured to perform the method 800 of FIG. 7. In at least some example embodiments, the processor 240 (FIG. 1) of the device 201 (FIG. 1) is configured to perform the method 800. One or more application 225 (FIG. 1) may contain computer readable instructions which cause the processor 240 (FIG. 1) of the device 201 (FIG. 1) to perform the method 800. It will be appreciated that the method 800 of FIG. 7 may, in at least some example embodiments, be provided by other software applications or modules apart from those specifically discussed above; for example, the operating system 223 (FIG. 1).

It will also be appreciated that, at least some of the method 800 of FIG. 8 may be performed by or may rely on other applications 225 (FIG. 1) or modules which interface with the contextual information determination module 279 (FIG. 1) and/or the contact manager 272 (FIG. 1). For example, in at least some example embodiments, access to one or more data stores (such as the message data store 308 (FIG. 2), calendar data store 310 (FIG. 2), and or location data store 312 (FIG. 2)) may be controlled by one or more associated applications 225 (such as the messaging application 276 (FIG. 1), calendar application 284 (FIG. 1) and location application 260 (FIG. 1)). In such example embodiments, the contextual information determination module 279 (FIG. 1) and/or the contact manager 272 (FIG. 1) may access the controlled data stores using application programming interface (API) calls to the application 225 associated with that data store.

Referring now to FIG. 7, at 802 a new contact entry 700 (FIG. 6) is received at the device 201 (FIG. 1). The contact entry 700 includes a contact identifier 420 (FIG. 6) which identifies one or more contact associated with the contact entry 700 (FIG. 6).

In at least some example embodiments, receiving the contact entry 700 (FIG. 6) at 802 includes receiving a request at the device 201 (FIG. 1) to create a new contact entry 700 (FIG. 6) at 804. The request may be received, for example, from an input interface 206 (FIG. 1) associated with the device 201 (FIG. 1). For example, the request may be received from a navigational input device, such as a trackball, track pad or touchscreen, which may be used to interact with a graphical user interface on the display screen 204 (FIG. 1) to input a request to the device 201 (FIG. 1) to create a new contact entry 700 (FIG. 6). In response to receiving such a request, the contact manager 272 (FIG. 1) may create a new contact entry 700 (FIG. 7).

Receiving the new contact entry 700 (FIG. 6) at 802 may also include, at 806, receiving a contact identifier 420 (FIG. 6) for the contact entry 700 (FIG. 6). The contact identifier 420 (FIG. 6) includes one or more identifier of the contact associated with the new contact entry 700 (FIG. 6). For example, the contact identifier 420 (FIG. 6) may specify a name and/or messaging address (such as an email address) for the contact. The contact identifier 420 (FIG. 6) may, in some example embodiments, be received from an input interface 206 (FIG. 1) associated with the device 201 (FIG. 1). For example, the contact identifier 420 (FIG. 6) may be input to the device 201 (FIG. 1) using a touchscreen or a physical keyboard associated with the device 201 (FIG. 1).

In other example embodiments (not shown), the contact entry 700 (FIG. 6) may be received, at 802, according to another method. For example, in at least some example embodiments, the contact entry 700 (FIG. 6) may be received at the device 201 (FIG. 1) via the communication subsystem 211 (FIG. 1). For example, in at least some example embodiments, the new contact entry 700 (FIG. 6) may be an attachment to an electronic message received at the device 201 (FIG. 1). The attachment may, for example, be a vCard. A vCard is a file format standard for electronic business cards. It will be appreciated that a received contact entry 700 (FIG. 6) may be in other forms not specifically discussed herein.

In response to receiving a new contact entry 700 (FIG. 6) the contextual information determination module 279 (FIG. 1) and/or the contact manager 272 (FIG. 1), at 808, identifies one or more associated records from one or more contextual information data stores 320 (FIG. 2) (such as the message data store 308 (FIG. 2), the calendar data store 310 (FIG. 2) and/or the location data store 312 (FIG. 2)). The contextual information data store 320 (FIG. 2) may be any data store from which contextual information may be determined.

In order to identify associated records at 808, the contextual information determination module 279 (FIG. 1) and/or the contact manager 272 (FIG. 1) may, at 810 search one or more contextual information data stores 320 (FIG. 2) to identify records which are associated with the same contact identifier 420 (FIG. 6) as the contact identifier 420 (FIG. 6) in the contact entry 700 (FIG. 6). In at least some example embodiments, at 810, the contextual information determination module 279 (FIG. 1) and/or the contact manager 272 (FIG. 1) searches the one or more contextual information data stores 320 (FIG. 2) to identify records which: 1) are associated with the same contact identifier 420 as the contact identifier 420 (FIG. 6) in the contact entry 700 (FIGS. 6); and 2) which also have a time identifier 422 (FIG. 3, 4, 5) which identifies a time that was prior to the time when the contact entry 700 (FIG. 6) was received. That is, records are identified which were in existence prior to the contact entry 700 being received.

For example, in at least some example embodiments, the contextual information determination module 279 (FIG. 1) and/or the contact manager 272 (FIG. 1) may, at 810, search a calendar data store 310 (FIG. 2) to identify any event records 500 (FIG. 4) associated with the contact identifier 420 (FIG. 6) in the contact entry 700 (FIG. 6) which were in existence prior to the contact entry 700 (FIG. 6) being received. The event records 500 (FIG. 4) include data for calendar events, such as, for example, an event name 505 (FIG. 4), an event location 507 (FIG. 4), and/or event attendees 513 (FIG. 4).

In at least some example embodiments, the contextual information determination module 279 (FIG. 1) and/or the contact manager 272 (FIG. 1) may, at 810, search a message data store 308 (FIG. 2) to identify any message records 400 (FIG. 3) associated with the contact identifier 420 (FIG. 6) in the contact entry 700 (FIG. 6) which were in existence prior to the contact entry 700 (FIG. 6) being received.

It will be appreciated that, not all of the contextual information data stores 320 (FIG. 2) are searched in all example embodiments. In some example embodiments, only one data store may be searched. For example, in at least some example embodiments, only the calendar data store 310 (FIG. 2) is searched. In other example embodiments, only the message data store 308 (FIG. 2) is searched.

In at least some example embodiments, identifying a record having a time identifier 422 which identifies a time that was prior to the time when the contact entry 700 (FIG. 6) was received does not involve examining the time identifier 422 (FIG. 3, 4, 5) itself. Since the identification of associated records at 808 occurs in response to receiving a new contact entry 700 (FIG. 6), typically the only records in existence in the contextual data stores 320 (FIG. 2) when the identification of associated records at 808 is performed are records which were in existence at the time when the contact entry 700 (FIG. 6) was received. Thus, in at least some example embodiments, all records in the contextual data store 320 (FIG. 2) may be identified as records having a time identifier identifying a time that was prior to the time when the contact entry 700 (FIG. 6) was received.

The contextual information data stores 320 (FIG. 2) which are searched at 810 are, in some example embodiments, stored in local memory on the device 201 (FIG. 1). For example, in the example embodiment of FIGS. 1 and 2, the contextual information data stores 320 (FIG. 2) are stored in flash memory 244 (FIG. 2) of the device 201.

In other example embodiments, one or more of the contextual information data stores 320 (FIG. 2) may be located remotely from the device 201 (FIG. 1). For example, contextual information data stores 320 may be located on a data store server (not shown). In such example embodiments, the processor 240 (FIG. 1) may be configured to access the contextual information data stores 320 on the data store server via the device's communication subsystem 211 (FIG. 1).

After searching, if no records are found which are associated with the contact identifier 420 (FIG. 6) in the contact entry (which may be determined at 812), then the method 800 may end. If, however, one or more records are identified in the contextual information data store 320 (FIG. 2) which are associated with the same contact identifier 420 (FIG. 6) as the contact entry 700 (FIG. 6), then at 814, the contextual information determination module 279 (FIG. 1) and/or the contact manager 272 (FIG. 1) may populate a portion of the contact entry 700 (FIG. 6) with data from one of the identified records. The data which is used to populate the portion of the contact entry 600 may be contextual information 760 (FIG. 6) which provides information regarding the relationship between the user of the device 201 (i.e. the owner of the contact entry 700 (FIG. 6)) and the contact associated with the contact entry 700 (FIG. 6).

The step 814 of populating the portion of the contact entry 700 (FIG. 6) includes, at 816, determining contextual information based on the record identified at 808 and also includes, at 818, populating a portion of the contact entry 700 (FIG. 6) with the contextual information. The specific contextual information which is determined at 816 and which is used for populating the contact entry at 818 may vary between example embodiments. Some example contextual information is, however, discussed below.

In at least some example embodiments, more than one record may be identified at 810. That is, 810 may include identifying, in one or more contextual information data store 320 (FIG. 2), a plurality of records which are each associated with the contact identifier 420 (FIG. 6) of the contact entry 700 (FIG. 6) and which each have a time identifier 422 having a time that is prior to the time when the contact entry 700 (FIG. 6) was received. As will be described in greater detail below, in at least some example embodiments, at 814, a portion of the contact entry 700 (FIG. 7) will be populated based on the time identifier 422 (FIG. 3, 4, 5) associated with one or more of the identified records. For example, as will be discussed below, in some example embodiments, a portion of the contact entry 700 (FIG. 6) may be populated with data from a record which is determined to represent the earliest interaction between the user of the device 201 and the contact associated with the contact entry 700 (FIG. 6). In other example embodiments, a portion of the contact entry 700 (FIG. 6) may be populated with data from a records which is determined to represent the most recent interaction between the user of the device 201 (FIG. 1) and the contact associated with the contact entry 700 (FIG. 6).

### Contextual Information Regarding Earliest Interaction

In at least some example embodiments, at 816, the contextual information determination module 279 (FIG. 1) and/or the contact manager 272 (FIG. 1) may determine contextual information 760 regarding the earliest interaction between the user of the device 201 (i.e. the owner of the contact entry 700 (FIG. 6)) and the contact associated with the contact entry 700. The contextual information determination module 279 (FIG. 1) and/or the contact manager 272 (FIG. 1) may do so, for example, by determining contextual information from the earliest record identified at 810. The earliest identified record is the identified record having the earliest time identifier. For example, with respect to message records, a message record may be determined to be earlier than another message record if it has an earlier sent time 415 (FIG. 3). Alternatively, a message record may be determined to be earlier than another message record if it has an earlier received time 417 (FIG. 3). With respect to calendar event records 500 (FIG. 4), a calendar event record may be determined to be earlier than another calendar event record if it has an earlier start time 509 (FIG. 4). Alternatively, a calendar event record may be determined to be earlier than another calendar event record if it has an earlier end time 511 (FIG. 5).

In some example embodiments, the contextual information may be determined by examining only a single contextual information data store 320 (FIG. 2). For example, in some example embodiments, only the calendar data store 310 (FIG. 2) is searched. In some example embodiments, only the message data store 308 (FIG. 2) is searched. However, in other example embodiments, multiple contextual information data stores 320 (FIG. 2) may be searched and the earliest record from any of these data stores may be relied upon. For example, if the earliest identified calendar event record 500 (FIG. 4) is earlier than the earliest identified message record 400 (FIG. 3), then the earliest calendar event record 500 (FIG. 4) may be relied upon to determine contextual information. If, however, the earliest identified message record 400 (FIG. 3) is earlier than the earliest identified calendar event record 500 (FIG. 4), then the earliest identified message record 400 (FIG. 3) may be relied upon.

In example embodiments in which contextual information 760 regarding the earliest interaction between the user and contact is determined, at 818, the contextual information determination module 279 (FIG. 1) and/or the contact manager 272 (FIG. 1) may populate a portion of the contact entry with the contextual information. For example, in at least some example embodiments, an earliest interaction field 719 may be populated with contextual information regarding the earliest interaction.

The contextual information regarding the earliest interaction may specify one or more of the following: the person who introduced the user to the contact, the subject of the first interaction between the user and the contact, the time of the first interaction between the user and contact, the location of the first interaction between the user and the contact, the purpose of the first interaction between the user and the contact, and/or the method used to meet during the first interaction between the user and the contact. Each of these types of contextual information will be discussed in greater detail below.

### Contextual Information Specifying the Person Who Introduced the User to the Contact

In some example embodiments, at 816, the contextual information determination module 279 (FIG. 1) and/or the contact manager 272 (FIG. 1) may determine, from the identified record(s), contextual information specifying the person who introduced the user of the device 201 to the contact defined in the contact entry 700. In at least some example embodiments, this determination may be made by determining, from identified message records 400 (FIG. 3), the name (from field 403 of FIG. 3) or messaging address (from field 405 of FIG. 3) of the person who sent the earliest message which included, as recipients, both the contact associated with the contact identifier 420 in the new contact entry 700 (FIG. 7) and the user of the device 201 (FIG. 1). In such example embodiments, the sender of that message may be selected as the person who introduced the user to the contact. In other example embodiments, the determination as to who introduced the user to the contact may be made by determining, from calendar event records 500 (FIG. 4), the organizer (from field 503 of FIG. 4) of the first event where the contact was an attendee. That is, by determining the organizer of the earliest calendar event record where the contact identifier 420 in the contact entry is listed as an attendee in the calendar event record (fields 513, 515 or 517 of FIG. 4). In such example embodiments, the organizer of that event may be selected as the person who introduced the user to the contact.

After the contextual information specifying the person who introduced the user of the device 201 (FIG. 1) to the contact defined in the contact entry 700 (FIG. 6) is determined, at 818, the contextual information determination module 279 (FIG. 1) and/or the contact manager 272 (FIG. 1) may populate a portion of the contact entry with this contextual information. For example, in at least some example embodiments, a field 721 (FIG. 6) for specifying the party who introduced the user to the contact may be populated with the contextual information.

### Contextual Information Specifying the Subject of the First Interaction

In at least some example embodiments, at 816, the contextual information determination module 279 (FIG. 1) and/or the contact manager 272 (FIG. 1) may determine, from the identified record(s), contextual information specifying the subject of the first interaction between the user of the device 201 and the contact identified by the contact identifier 420 of the contact entry 700 (FIG. 6). In at least some example embodiments, this determination may be made by determining, from the identified message records 400 (FIG. 3), the subject (from field 411 of FIG. 3) of the earliest message record 400 (FIG. 3). In such example embodiments, the subject of the earliest message record 400 (FIG. 3) may be selected as the subject of the first interaction between the user of the device 201 (FIG. 1) and the contact identified by the contact identifier 420 in the new contact entry 700 (FIG. 6). In some example embodiments, this determination may be made by determining, from calendar event records 500 (FIG. 4) the event name (from field 505 of FIG. 4) of the earliest calendar event record where the contact identifier 420 in the contact entry is listed as an attendee in the calendar event record (fields 513, 515 or 517 of FIG. 4). In such example embodiments, the event name 505 (FIG. 4) of that event may be selected as the subject of the first interaction between the user of the device 201 (FIG. 1) and the contact.

After the contextual information specifying the subject of the first interaction between the user of the device 201 (FIG. 1) and the contact is determined, at 818, the contextual information determination module 279 (FIG. 1) and/or the contact manager 272 (FIG. 1) may populate a portion of the contact entry with this contextual information. For example, in at least some example embodiments, a field 723 (FIG. 6) for specifying the subject of a first interaction with the contact may be populated with the contextual information.

### Contextual Information Specifying the Time of the First Interaction

In at least some example embodiments, at 816, the contextual information determination module 279 (FIG. 1) and/or the contact manager 272 (FIG. 1) may determine, from the identified record(s), contextual information specifying the time (i.e. in terms of the time of day and date) of the first interaction between the user of the device and the contact associated with the contact identifier 420 in the contact entry 700 (FIG. 6). In at least some example embodiments, this determination may be made by determining, from the identified message records 400 (FIG. 3), a time identifier 422 (from field 415 or 417 of FIG. 3) of the earliest message record 400 (FIG. 3). In such example embodiments, the time identifier 422 of the earliest message record 400 (FIG. 3) may be selected as the time of the first interaction between the user of the device 201 and the contact identified by the contact identifier 420. Similarly, in some example embodiments, the determination of the time of the first interaction may be made by determining, from calendar event records 500 (FIG. 4) the time identifier 422 (from fields 509 or 511 of FIG. 4) of the earliest calendar event record where the contact identifier 420 in the contact entry is listed as an attendee in the calendar event record (fields 513, 515 or 517 of FIG. 5). In such example embodiments, a time identifier 422 (FIG. 4) for that event may be selected as the time of the first interaction between the user of the device 201 and the contact.

After the contextual information specifying the time (i.e. in terms of the time of day and date) of the first interaction between the user of the device and the contact is determined, at 818, the contextual information determination module 279 (FIG. 1) and/or the contact manager 272 (FIG. 1) may populate a portion of the contact entry with this contextual information (i.e. the time identifier of the identified record). For example, in at least some example embodiments, a field 725 (FIG. 6) for specifying the time (i.e. in terms of the time of day and date) of the first interaction between the user of the device 201 (FIG. 1) and the contact defined in the contact entry 700 may be populated with the contextual information.

### Contextual Information Specifying the Location of the First Interaction

In at least some example embodiments, at 816, the contextual information determination module 279 (FIG. 1) and/or the contact manager 272 (FIG. 1) may determine, from the identified record(s), contextual information specifying the location of the first interaction between the user of the device and the contact associated with the contact identifier 420 in the contact entry 700 (FIG. 6). In some example embodiments, this determination may be made by determining, from calendar event records 500 (FIG. 4), the event location (from field 507 of FIG. 4) of the earliest calendar event record 500 (FIG. 4) where the contact identifier 420 in the contact entry is listed as an attendee (i.e. in fields 513, 515 or 517 of FIG. 4). In such example embodiments, the event location for that event may be selected as the location of the first interaction between the user of the device 201 and the contact.

In other example embodiments, the determination of the location of the first interaction may be made by determining, from calendar event records 500, one or more time identifiers 420 (such as start time 509 and end time 511 of FIG. 4) associated with the earliest calendar event record 500 (FIG. 4) where the contact identifier 420 in the contact entry is listed as an attendee (i.e. in fields 513, 515 or 517 of FIG. 4). After determining the time identifier(s), the contextual information determination module 279 (FIG. 1) and/or the contact manager 272 (FIG. 1) may determine, from the location data store 312, the location of the device 201 during the event. For example, one or more location records 600 (FIG. 5) may be located which have a time 605 that corresponds to the time associated with the earliest calendar event record 500 (FIG. 4) where the contact identifier 420 in the contact entry is listed as an attendee (i.e. in fields 513, 515 or 517 of FIG. 4). That is, the location of the device 201 during the event is determined.

After the contextual information specifying the location of the first interaction between the user of the device and the contact is determined, at 818, the contextual information determination module 279 (FIG. 1) and/or the contact manager 272 (FIG. 1) may populate a portion of the contact entry with this contextual information. For example, in at least some example embodiments, a field 727 (FIG. 6) for specifying the location of the first interaction between the user of the device 201 (FIG. 1) and the contact defined in the contact entry 700 may be populated with the contextual information.

### Contextual Information Specifying Additional Information Regarding the Purpose the First Interaction

In at least some example embodiments, at 816, the contextual information determination module 279 (FIG. 1) and/or the contact manager 272 (FIG. 1) may determine, from the identified record(s), contextual information specifying additional information regarding the purpose of the first interaction between the user of the device and the contact associated with the contact identifier 420 in the contact entry 700 (FIG. 6). In at least some example embodiments, this determination may be made by determining, from the identified message records 400 (FIG. 3), a message body (from field 413 of FIG. 3) of the earliest message record 400 (FIG. 3). In such example embodiments, the message body of the earliest message record 400 (FIG. 3) may be selected as the additional information regarding the purpose of the first interaction between the user of the device and the contact.

Similarly, in some example embodiments, additional information regarding the purpose of the first interaction between the user of the device and the contact may be made by determining, from calendar event records 500 (FIG. 4) the body (field 519 of FIG. 4) of the earliest calendar event record where the contact identifier 420 in the contact entry is listed as an attendee in the calendar event record (fields 513, 515 or 517 of FIG. 4). In such example embodiments, the body (i.e. the contents of field 519 of FIG. 4) for that event may be selected as the purpose of the first interaction between the user of the device and the contact.

After the contextual information specifying additional information regarding the purpose of the first interaction between the user of the device and the contact is determined, at 818, the contextual information determination module 279 (FIG. 1) and/or the contact manager 272 (FIG. 1) may populate a portion of the contact entry with this contextual information. For example, in at least some example embodiments, a field 729 (FIG. 6) for specifying the reason for the first interaction between the user of the device 201 (FIG. 1) and the contact defined in the contact entry 700 may be populated with the contextual information.

### Contextual Information Specifying the Method Used to Meet

In at least some example embodiments, at 816, the contextual information determination module 279 (FIG. 1) and/or the contact manager 272 (FIG. 1) may determine, from the identified record(s), contextual information specifying the method used to meet during the first interaction between the user of the device and the contact associated with the contact identifier 420 in the contact entry 700 (FIG. 6). In some example embodiments, this determination may be made by searching the earliest calendar event record 500 (FIG. 5) where the contact identifier 420 in the contact entry is listed as an attendee (i.e. in fields 513, 515 or 517 of FIG. 4) for various keywords or content. For example, if the calendar event record contains a telephone number in a predetermined location of the calendar event record 500 (such as the event location field 507 of FIG. 4), then it may be determined that the method used to meet was a telephone conference. Similarly, if the word “call” or its variants is found in a predetermined location of the calendar event record 500, then it may be determined that the method used to meet was a telephone conference.

In some example embodiments, the contextual information determination module 279 (FIG. 1) and/or the contact manager 272 (FIG. 1) may determine whether the calendar event record 500 includes a webinar link. For example, in some example embodiments, the calendar event record 500 may be determined to include a webinar link if a URL is included in a predetermined location of the calendar event record 500. If the calendar event record 500 includes a webinar link, then the method used to meet may be determined to be a webinar.

In some example embodiments, the contextual information determination module 279 (FIG. 1) and/or the contact manager 272 (FIG. 1) may determine whether the first meeting was an in-person meeting. For example, in at least some example embodiments, the contextual information determination module 279 (FIG. 1) and/or the contact manager 272 (FIG. 1) may determine whether a predetermined location of the calendar event record 500 includes an address. In some example embodiments, the predetermined location is a field 507 (FIG. 4) which stores an event location. In other example embodiments, the predetermined location is afield 519 which stores the body of the calendar event.

After the contextual information specifying the method used to meet during the first interaction between the user of the device and the contact is determined, at 818, the contextual information determination module 279 (FIG. 1) and/or the contact manager 272 (FIG. 1) may populate a portion of the contact entry with this contextual information. For example, in at least some example embodiments, a field 731 (FIG. 6) for specifying the method used to meet during the first interaction (i.e. videoconference, telephone, in-person) may be populated with the contextual information.

### Contextual Information Regarding Most Recent Interaction

In at least some example embodiments, at 816, the contextual information determination module 279 (FIG. 1) and/or the contact manager 272 (FIG. 1) may determine contextual information 760 regarding the most recent interaction between the user of the device 201 ((i.e. the owner of the contact entry 700 (FIG. 6)) and the contact associated with the contact entry 700. The contextual information determination module 279 (FIG. 1) and/or the contact manager 272 (FIG. 1) may do so, for example, by determining contextual information from the most recent record identified at 810. The most recent identified record is the identified record having the latest time identifier. For example, with respect to message records, a message record may be determined to be more recent than another message record if it has a later sent time 415 (FIG. 3). Alternatively, a message record may be determined to be more recent than another message record if it has a later received time 417 (FIG. 3). With respect to calendar event records 500 (FIG. 4), a calendar event record may be determined to be more recent than another calendar event record if it has a later start time 509 (FIG. 4). Alternatively, a calendar event record may be determined to be more recent than another calendar event record if it has a later end time 511 (FIG. 4).

In example embodiments in which contextual information 760 regarding the most recent interaction between the user and contact is determined, at 818, the contextual information determination module 279 (FIG. 1) and/or the contact manager 272 (FIG. 1) may populate a portion of the contact entry with the contextual information. For example, in at least some example embodiments, a most recent interaction field 735 may be populated with contextual information regarding the most recent interaction.

The contextual information regarding the most recent interaction may specify any of the information discussed above with reference to the earliest interaction. For example, it may include one or more of the following: the subject of the most recent interaction between the user and the contact, the time of the most recent interaction between the user and contact, the location of the most recent interaction between the user and the contact, the purpose of the most recent interaction between the user and the contact, and/or the method used to meet during the most recent interaction between the user and the contact. Such contextual information may be determined by examining the most recent record identified at 810 in the same manner in which the earliest record was examined in the discussion above.

### Prompting for Populating Contact Entry

In some example embodiments, such as the example embodiment illustrated in FIG. 7, the contact entry 700 (FIG.6) may be automatically populated with contextual information after contextual information is determined. That is, the contact entry 700 (FIG. 7) may be populated without the need for further input from the user via an input interface 206 (FIG. 1).

In other example embodiments, further user input may be required from a user via an input interface 206 (FIG. 1) in order to populate the contact entry 700 with the contextual information. Referring now to FIG. 8, one such example embodiment is illustrated. In FIG. 8, a flowchart of a further method 900 for populating a contact entry 700 (FIG. 6) is illustrated. The device 201 (FIG. 1) may be configured to perform the method 900 of FIG. 8. In at least some example embodiments, the processor 240 (FIG. 1) of the device 201 (FIG. 1) is configured to perform the method 900. One or more application 225 (FIG. 1) or module stored in memory of the device 201 (FIG. 1) may contain computer readable instructions which cause the processor 240 (FIG. 1) of the device 201 (FIG. 1) to perform the method 900. In at least some example embodiments, the contact manager 272 (FIG. 1) and/or the contextual information determination module 279 (FIG. 1) stored in memory of the device 201 (FIG. 1) are configured to perform the method 900 of FIG. 8. More particularly, the contact manager 272 (FIG. 1) and/or the contextual information determination module 279 (FIG. 1) may include computer readable instructions which, when executed, cause the processor 240 (FIG. 1) to perform the method 900 of FIG. 8. It will be appreciated that the method 900 of FIG. 8 may, in at least some example embodiments, be provided by other software applications or modules apart from those specifically discussed above; for example, the operating system 223 (FIG. 1).

It will also be appreciated that, at least some of the method 900 of FIG. 8 may be performed by or may rely on other applications or modules which interface with the contextual information determination module 279 (FIG. 1) and/or the contact manager 272 (FIG. 1). For example, in at least some example embodiments, access to one or more data stores (such as the message data store 308 (FIG. 2), calendar data store 310 (FIG. 2), and or location data store 312 (FIG. 2)) may be controlled by one or more associated applications 225 (such as the messaging application 276 (FIG. 1), calendar application 284 (FIG. 1) and location application 260 (FIG. 1)). In such example embodiments, the contextual information determination module 279 (FIG. 1) and/or the contact manager 272 (FIG. 1) may access the controlled data stores using application programming interface (API) calls to the application 225 associated with that data store.

The method 900 includes steps 802, 804, 806, 808, 810, 812, 814, 816, 818 which are discussed in greater detail above with reference to FIG. 7. However, the method 900 includes additional steps 920, 922 which are not depicted in FIG. 7. More particularly, after determining the contextual information at 816, at 920 the contextual information determination module 279 (FIG. 1) and/or the contact manager 272 (FIG. 1) presents a prompt via an output interface 205 (FIG. 1) of the device 201 (FIG. 1) to request confirmation to populate the contact entry 700 (FIG. 6) with the contextual information determined at 816. The prompt may, in at least some embodiments, be provided on a display screen 204 (FIG. 1) of the device 201 (FIG. 1). The prompt may, in various example embodiments, ask the user to confirm, cancel, or modify the contextual information.

Where multiple matching records are found, or where the process proceeds by successive stages of matching, the user may be presented with multiple prompts, or may be presented with a list of matching records and asked to select which contextual information, if any, should be used for populating the contact entry.

Next, at 922, confirmation may be received via an input interface 206 (FIG. 1) associated with the device 201 (FIG. 1). The input interface 206 (FIG. 1) may, for example, be a trackpad, trackball, keyboard, or touchscreen. In response to receiving confirmation at 922, the contextual information determination module 279 (FIG. 1) and/or the contact manager 272 (FIG. 1) populate a portion of the contact entry 700 (FIG. 6) with contextual information at 818. If, no confirmation is received at 922 (i.e. if the user instructs the device 201 (FIG. 1) to not populate'the contact entry with the contextual information), then the method 900 ends without populating the contact entry with the contextual information.

### Organisation Charts

In at least some example embodiments, contact entries 700 (FIG. 6) may be populated with data from an organisation chart. An organisation chart (which may also be referred to as an organisational chart) is a data store which includes information regarding an organization. Such information may include, for example, information regarding the structure of an organization and the relationships and relative ranks of its parts and positions. The organization chart (not illustrated) may include a plurality of organisation chart personnel records.

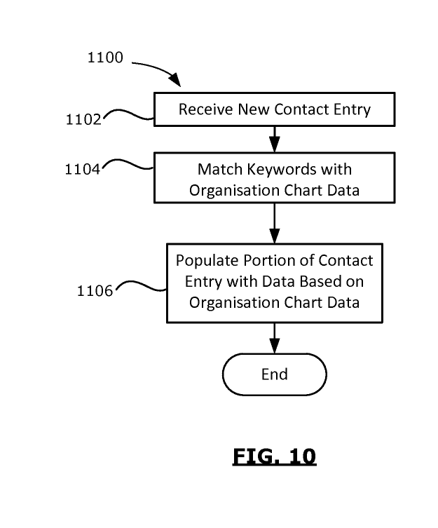

Referring now to FIG. 9, an organization chart record 1000 according to an example embodiment is illustrated. The organisation chart record 1000 relates to an entry in an organisation chart for a company or other organisation, and may be managed by the contact manager 272 (FIG. 1) or by another application. It contains several data fields including company name 1003, department 1009, job title 1011, office location 1013, phone number 1015, and business address 1019, and one or more contact identifiers 420 which may be used to identify an individual associated with the organisation chart record 1000. In the example embodiment shown, the contact identifiers include an email address 1017, a first name 1005, and a last name 1007.

In some example embodiments, the organisation chart record 1000 may be specific to a dedicated organisation chart application, and may make use of specialized data structures not used by the contact manager 272 (FIG. 1); for example, the office location field 1013 may be populated by a value drawn from a predetermined list of locations corresponding to the company listed in the company name field 1003.

In at least some example embodiments, the organisation chart personnel record 1000 may be used to populate additional fields in the contact entry 700 (FIG. 6). Referring now to FIG. 10, a method 1100 for populating the contact entry 700 (FIG. 6) with data from an organization chart is illustrated.

The device 201 (FIG. 1) may be configured to perform the method 1100 of FIG. 10. In at least some example embodiments, the processor 240 (FIG. 1) of the device 201 (FIG. 1) is configured to perform the method 1100. More particularly, in at least some example embodiments, one or more application 225 (FIG. 1) or module stored in memory of the device 201 (FIG. 1) may be configured to perform the method 1100 of FIG. 10. One or more application 225 (FIG. 1) may contain computer readable instructions which cause the processor 240 (FIG. 1) of the device 201 (FIG. 1) to perform the method 1100. In at least some example embodiments, the contact manager 272 (FIG. 1) and/or the contextual information determination module 279 (FIG. 1) stored in memory of the device 201 (FIG. 1) are configured to perform the method 1100 of FIG. 10. More particularly, the contact manager 272 (FIG. 1) and/or the contextual information determination module 279 (FIG. 1) may include computer readable instructions which, when executed, cause the processor 240 (FIG. 1) to perform the method 1100 of FIG. 10. It will be appreciated that the method 1100 of FIG. 10 may, in at least some example embodiments, be provided by other software applications or modules apart from those specifically discussed above; for example, the operating system 223 (FIG. 1).

It will also be appreciated that, at least some of the method 1100 of FIG. 10 may be performed by or may rely on other applications or modules which interface with the contextual information determination module 279 (FIG. 1) and/or the contact manager 272 (FIG. 1). For example, in at least some example embodiments, access to one or more data stores (such as the message data store 308 (FIG. 2), calendar data store 310 (FIG. 2), and or location data store 312 (FIG. 2)) may be controlled by one or more associated applications 225 (such as the messaging application 276 (FIG. 1), calendar application 284 (FIG. 1) and location application 260 (FIG. 1)). In such example embodiments, the contextual information determination module 279 (FIG. 1) and/or the contact manager 272 (FIG. 1) may access the controlled data stores using application programming interface (API) calls to the application 225 associated with that data store.

First, at 1102, a new contact entry 700 is received. One or more fields of the new contact entry 700 may be populated. In response to receiving a new contact entry 700 (FIG. 6), at 1104, the contextual information determination module 279 (FIG. 1) and/or the contact manager 272 (FIG. 1) may perform a keyword search of the organisation chart using at least some of the data in the contact entry 700 (FIG. 6) and may, at 1106, populate a portion of the contact entry with at least some data from the organisation chart.

For example, in at least some example embodiments, the contextual information determination module 279 (FIG. 1) and/or the contact manager 272 (FIG. 1) may search organisation chart records 1000 (FIG. 9) for a company 711 (FIG. 6) identified in the new contact entry 700 (FIG. 6). If a match is found, then data from the matching record may be used (at 1106) to populate fields of the new contact entry 700 (FIG. 6). For example, the phone field 709 (FIG. 6) of the new contact entry (FIG. 6) may be populated with the phone number 1015 (FIG. 9) of the identified organisation chart record 1000 (FIG. 9). Similarly, the address field 717 (FIG. 6) of the new contact entry (FIG. 6) may be populated with the address 1019 (FIG. 9) of the identified organisation chart record 1000 (FIG. 9).

In some example embodiments, the organisation chart records 1000 (FIG. 9) each relate to a specific individual within a company. In such example embodiments, at 1104, a record for an individual corresponding to a contact identifier 420 in the contact entry 700 (FIG. 6) is located and, at 1106, a portion of the contact entry is populated with data from the record for the individual. The data which may be used to populate the contact entry 700 may include, for example, any of the data in the example organisation chart record 1000 of FIG. 9.

In at least some example embodiments, where a new contact entry 700 includes an email address, the domain of the email address (i.e. the portion following the “@” symbol) could be used at 1104 as a basis for matching email addresses. That is, a record in the organization chart which contains an email having the same domain may be used to populate one or more portions of the contact entry 700 (FIG. 6). The company name 1003, office location 1013, phone 1015 and/or business address 1019 in such a record may be used to populate the contact entry 700 (FIG. 6).

It will be appreciated that, in other example embodiments (not shown), the methods and systems described herein may be applied to records or documents apart from contact entries 700 (FIG. 6). For example, one such example embodiment may populate a record or document created between the start and end times of an event record 500 (FIG. 4) with data from that event record 500 (FIG. 4). For example, notes or minutes from a meeting created in a word processing application may have data or metadata about the meeting (such as subject, location, and attendees) added to the final document when it is saved, by comparing the edit or creation time of the document with the start and end times of the meeting event record. A device 201 (FIG. 1) having a camera as one of its input devices 206 may similarly have metadata about an event added to a picture file when a picture is taken between the start and end times of the event. The process of populating these documents or records may involve an interactive series of prompts to the user to confirm, cancel, or modify the data used to populate the documents or records.

The timing of the population process may also be varied in alternative example embodiments. While some example embodiments may run the population process at the time that a new contact entry or other record is created, other example embodiments may populate past entries or records after they are created. Furthermore, an entry or record may be updated or further populated after the first time it is populated; for example, some example embodiments may periodically update contact entries' lists of recent interactions.

While the present disclosure is primarily described in terms of methods, a person of ordinary skill in the art will understand that the present disclosure is also directed to various apparatus such as a handheld electronic device including components for performing at least some of the aspects and features of the described methods, be it by way of hardware components, software or any combination of the two, or in any other manner. Moreover, an article of manufacture for use with the apparatus, such as a pre-recorded storage device or other similar computer readable medium including program instructions recorded thereon, or a computer data signal carrying computer readable program instructions may direct an apparatus to facilitate the practice of the described methods. It is understood that such apparatus, articles of manufacture, and computer data signals also come within the scope of the present disclosure.

The term “computer readable medium” as used herein means any medium which can store instructions for use by or execution by a computer or other computing device including, but not limited to, a portable computer diskette, a hard disk drive (HDD), a random access memory (RAM), a read-only memory (ROM), an erasable programmable-read-only memory (EPROM) or flash memory, an optical disc such as a Compact Disc (CD), Digital Versatile Disc (DVD) or Blu-ray™ Disc, and a solid state storage device (e.g., NAND flash or synchronous dynamic RAM (SDRAM)).

Example embodiments of the present disclosure are not limited to any particular operating system, system architecture, mobile device architecture, server architecture, or computer programming language.

The various embodiments presented above are merely examples and are in no way meant to limit the scope of this disclosure. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A method performed by an electronic device having a memory and a processor coupled with the memory, the method comprising:
receiving a contact entry, the contact entry having a contact identifier;
identifying, in a data store, a record which is associated with the contact identifier and which has a time identifier identifying a time that was prior to the time when the contact entry was received; and
populating a portion of the contact entry with data from the identified record.

2. The method of claim 1, wherein identifying the record comprises identifying, in the data store, a plurality of records which are each associated with the contact identifier and which each have a time identifier having a time that is prior to the time when the contact entry was received, and wherein populating the portion of the contact entry comprises populating the portion of the contact entry with data from one or more of the identified records based on the time identifier associated with one or more of the identified records.

3. The method of claim 2, wherein populating the portion of the contact entry comprises populating the portion of the contact entry with data from the identified record having the earliest time identifier.

4. The method of claim 2, wherein populating at least a portion of the contact entry comprises populating the portion of the contact entry with data from a identified record having the latest time identifier.

5. The method of claim 1, further comprising:
identifying a location of the electronic device that corresponds with the time identifier of the record; and
populating a portion of the contact entry with the identified location.

6. The method of claim 1, wherein the contact identifier comprises a name.

7. The method of claim 1, wherein the data comprises the time identifier of the record.

8. The method of claim 1, wherein the data store comprises a calendar data store and the identified record in the data store includes data for a calendar event.

9. The method of claim 8, wherein data for the calendar event comprises at least one of an event name, an event location and event attendees.

10. The method of claim 1, further comprising:
identifying, in an organisation chart, a record for an individual corresponding to the contact identifier and populating a portion of the contact entry with data from the record for the individual.

11. The method of claim 10, wherein populating the portion of the contact entry comprises populating the portion of the contact entry with at least one of a job title, a department name, an office location, a phone number, an email address and a location address from the record for the individual.

12. The method of claim 1, wherein the data store is stored in the memory of the electronic device.

13. The method of claim 1, wherein the electronic device further comprises a communication subsystem and wherein receiving the contact entry comprises receiving the contact entry via the communication subsystem.

14. The method of claim 1, wherein the electronic device further comprises an output interface coupled with the processor, the method further comprising presenting a prompt via the output interface for requesting confirmation to populate the portion of the contact entry with data from the record.

15. The method of claim 1, wherein the electronic device further comprises an input interface coupled with the processor, and wherein the method further comprises receiving confirmation, from the input interface, to populate the portion of the contact entry with data from the record.

16. The method of claim 1, wherein the data store is stored on a server which is accessed via a communication subsystem on the electronic device.

17. An electronic device comprising:
a memory; and
a processor coupled with the memory, the processor being configured to:
receive a contact entry, the contact entry having a contact identifier;
identify, in a data store, a record which is associated with the contact identifier and which has a time identifier identifying a time that was prior to the time when the contact entry was received; and
populate a portion of the contact entry with data from the identified record.

18. The electronic device of claim 17, wherein the electronic device is a mobile communications device.

19. (canceled)

20. A method for populating a portion of a contact entry, the contact entry having a contact identifier, the method comprising:
identifying, in a data store, an earliest record which is associated with the contact identifier; and
populating at least a portion of the contact entry based on information contained in the identified record.

21. The electronic device of claim 17, wherein the processor is further configured to
identify a location of the electronic device that corresponds with the time identifier of the record; and
populate a portion of the contact entry with the identified location.
